(19) United States
(12) Patent Application Publication
(10) Pub. No.: US 2015/0235133 A1
(43) Pub. Date: Aug. 20, 2015

(54) DATA CONCENTRATION PREDICTION DEVICE, DATA CONCENTRATION PREDICTION METHOD, AND RECORDING MEDIUM RECORDING PROGRAM THEREOF

(71) Applicant: NEC CORPORATION, Minato-ku, Tokyo (JP)

(72) Inventor: Kenji Aoki, Tokyo (JP)

(73) Assignee: NEC CORPORATION, Minato-ku, Tokyo (JP)

(21) Appl. No.: 14/427,038

(22) PCT Filed: Sep. 10, 2013
(86) PCT No.: PCT/JP2013/074367

§ 371 Date: Mar. 10, 2015

(30) Foreign Application Priority Data
Sep. 12, 2012 (JP) 2012-200440

(51) Int. Cl. G06N 5/04; G06N 99/00

(52) U.S. Cl. CPC G06N 5/04; G06N 99/005

(57) ABSTRACT

[Problem] To provide a data concentration prediction device accurately predicting data concentration by analytically processing additional learning data extracted from within a necessary-sufficient range; a method thereof; and a program thereof. [Solution] A data concentration prediction means (31) analyzing, using a data storage means (21), a data structure of time-series data received by a data input means (11) to predict subsequent data concentration includes a learning data extraction processing unit (41) continuously extract-processes, as additional learning data necessary for predicting the subsequent data concentration, the time-series data deviating from a fluctuation permission range preset on the basis of time-series data within a past fixed period based on a time point immediately preceding an input time point of each time-series data. A prediction processing unit (71) calculates a prediction value concerning future data concentration on the basis of processed information resulting from subjecting the additional learning data to various calculation processes.

### TECHNICAL FIELD

The present invention relates to a data concentration prediction device that, in order to predict future data concentration, extracts significant information included in time-series data and accurately performs learning and prediction processes based on the extracted information, a method thereof, and a program thereof.

### BACKGROUND ART

Along with development of sensing techniques and information management techniques, extraction of useful knowledge (information on regularity and the like) from time-series data accumulated over time has been one of the recent major issues in the fields of machine learning and data mining. Machine learning is a technique for extracting useful knowledge from a large amount of data using a computer program. Data mining is a technique for extracting useful knowledge by a data analysis technique such as statistics.

Herein, the time-series data represents data concerning a natural phenomenon such as an earthquake waveform or sea level fluctuation in tsunami. In addition, the time-series data also represents data concerning a state of each component obtained from sensors installed on vehicles or factory lines. Additionally, the time-series data also represents data concerning changes in sales volume and data concerning congestion caused by moving bodies such as pedestrians. In addition, the time-series data represents contents and numbers of articles posted over time to social media such as Twitter (registered trademark) and blogs on the Web. Furthermore, the time-series data represents a wide range of data including data concerning human activities, such as power consumption in daily life. Additionally, pieces of useful knowledge extracted from the various kinds of data as above vary with the kind of the data and the purpose of use thereof.

Examples of indexes for extracting the pieces of such useful knowledge include criteria for determining whether a given time-series pattern is normal or abnormal and mathematical models for predicting a future observation value on the basis of an observation value at a specific time point. The time-series pattern is the pattern of a data structure appearing in time-series data. Extraction of useful knowledge using such an index is realized by learning a substantial data structure existing behind time-series data accumulated from the past to the present.

As an algorithm of the criteria for determination or the mathematical models, a statistical technique or the like based on various kinds of empirically obtained data is often employed. Accordingly, in general, accuracy concerning prediction of determination of normality or abnormality or a future observation value is more stable as an amount of accumulation of learning data (useful knowledge to be extracted and stored) is larger to some extent. In addition, when a significant time-series pattern that has never been observed before newly appears with the passage of time, additionally processing the new one as learning data allows improvement in processing accuracy for determination and prediction.

In other words, in order to accurately perform determination processing and prediction processing by a learning device using time-series data as a target, a function is needed that periodically receives newly accumulated learning data and also relearns the received new learning data together with learning data accumulated by that time.

On the other hand, in scenes of many applications requiring determination and prediction, data not suitable for relearning can also be mixed. Due to that, in a situation where the above relearning function is operated at all times, there is a problem with the waste of time caused by unnecessary calculation processes. In addition, new receiving of data not containing any significant time-series pattern as learning data reduces accuracies of subsequent determination processing and prediction processing. Furthermore, in order to solve such a problem, when a user is adapted to evaluate each time as to whether newly accumulated data is appropriate as learning data, there arise new problems such as increased human cost and occurrence of human errors.

Accordingly, in order to achieve more suitable prediction processing and the like, there is a need for a system that automatically and accurately evaluate (determine) appropriateness of time-series data accumulated over time, as additional learning data, and also effectively relearn appropriate additional learning data extracted by the evaluation.

Among related art in the fields of machine learning and data mining, for example, the following technical contents (Patent Literature 1 to 4 and Non Patent Literature 1) are known.

Patent Literature 1 discloses a technique in which, for purposes of highly accurate prediction of sales volume and maintainability improvement of a prediction model, the degree of a polynomial regression is calculated from time-series data of sales volume results, and when a result value in a month is out of a range of from a lower limit value to an upper limit value of a confidence limits, a sales volume result of the corresponding month is extracted as an abnormal value. In Patent Literature 1, highly accurate prediction of sales volume results is expected by correction of an abnormal value extracted by the technique on the basis of a result value of a preceding month

Patent Literature 2 discloses a technique in which a prediction model is updated in real-time from observation results of moving bodies in an observation area to perform future congestion prediction, and future coming of moving bodies is temporarily caused by using a non-homogeneous Poisson process model. In Patent Literature 2, upon request for congestion prediction, the prediction model is updated using, as an initial value, moving body information represented by a matrix at the time of the request

Patent Literature 3 discloses a technical content that, in a prediction system for predicting a future value from a past value of time-series data, eliminates, as noise, values before a changing point at which a value of the time-series data deviates from a normal fluctuation tendency, and uses values thereafter for prediction. Patent Literature 4 discloses a technical content that detects data at the time of occurrence of abnormality from among time-series data input from various sensors to extract time-series data within a preset fixed interval ranging before and after the detected data.

Non Patent Literature 1 describes a technique referred to as an active learning for automatically evaluating appropriateness as learning data. The literature discloses a technical content that selects relatively appropriate learning data from among a plurality of resampled learning data candidates using an existing passive learning algorithm.

### CITATION LIST

### Patent Literature

PTL 1: Japanese Unexamined Patent Application Publication No. H07-064965
PTL 2: Japanese Unexamined Patent Application Publication No. 2004-213098
PTL 3: Japanese Unexamined Patent Application Publication No. 2010-108283
PTL 4: Japanese Unexamined Patent Application Publication No. 2005-346655

### Non Patent Literature

NPL 1: ‘bit, separate volume, Discovery and Data Mining’, edited by Shinichi Morishita & Satoru Miyano, Kyoritsu Shuppan Co., Ltd., 5 May, 2000, pp. 64-72.

### SUMMARY OF INVENTION

### Technical Problem

However, the technique that corrects an abnormal value of time-series data (Patent Literature 1), uses time-series data as learning data at the time of a prediction request (Patent Literature 2), or uses time-series data after the changing point as learning data (Patent Literature 3) does not improve accuracy of a prediction model for predicting changes per se in time-series data. Then, a combination technique thereof also does not improve the accuracy of a prediction model for predicting changes per se in time-series data. In addition, the fixed interval for extracting peripheral data at the time of occurrence of abnormality disclosed in Patent Literature 4 is a uniform interval to be preset, and there is no disclosure about a technical content that flexibly sets the interval by correlating with a fluctuation tendency of a variety of data.

Furthermore, Patent Literature 3 does not disclose any technical content for extracting significant information included in time-series data. Additionally, in the active learning method disclosed in Non Patent Literature 1, there is no disclosure about any technical content determining whether given learning data is absolutely appropriate or not.

### OBJECT OF THE PRESENT INVENTION

It is an object of the present invention to provide a data concentration prediction device that improves disadvantages of the above-described related art and accurately predicts, particularly, subsequent data concentration in time-series data, a method thereof, and a program thereof.

### Solution to Problem

To achieve the above object, a data concentration prediction device according to the present invention is adapted to include: a data input means for receiving data transmitted from a plurality of nodes together with corresponding attribute data to receive as time-series data; a data storage means for storing the received time-series data; and a data concentration prediction means for analyzing a data structure of the stored time-series data to predict subsequent data concentration, the data concentration prediction means including a learning data extraction processing unit that temporarily store-processes the time-series data received by the data input means, over time at each preset unit time point, and continuously extract-processes, as additional learning data necessary for predicting the subsequent data concentration, the time-series data deviating from a fluctuation permission range preset on the basis of time-series data within a past fixed period based on a time point immediately preceding an input time point of each time-series data using the temporarily store-processed data, and the learning data extraction processing unit including a learning data storage processing function that collectively store-processes the continuously extracted additional learning data in the data storage means.

A data concentration prediction method according to the present invention is adapted to be performed with a data concentration prediction device including a data input means for receiving data transmitted from a plurality of nodes together with corresponding attribute information to receive as time-series data, a data storage means for storing the received time-series data, and a data concentration prediction means for analyzing a data structure of the stored time-series data to predict subsequent data concentration, the data concentration prediction means including a learning data extraction processing unit that extracts and processes time-series data for predicting the data concentration, in which the method includes: temporarily store-processing the time-series data received by the data input means, over time at each preset unit time point; determining whether or not each time-series data deviates from a fluctuation permission range set on the basis of time-series data within a past fixed period based on a time point immediately preceding an input time point of each time-series data using the temporarily store-processed data; when deviation from the fluctuation permission range is determined, continuously extracting time-series data concerning the determination as additional learning data necessary for predicting the subsequent data concentration; collectively store-processing the continuously extracted additional learning data in the data storage means, the series of respective step contents being executed in order by the learning data extraction processing unit; and causing a prediction processing unit of the data concentration prediction means to predict the data concentration on the basis of a data structure of time-series data specified by the additional learning data collectively stored in the data storage means and existing learning data.

Furthermore, a data concentration prediction program according to the present invention is adapted to be executed with a data concentration prediction device including a data input means for receiving data transmitted from a plurality of nodes together with corresponding attribute information to receive as time-series data, a data storage means for storing the received time-series data, and a data concentration prediction means for analyzing a data structure of the stored time-series data to predict subsequent data concentration, in which the program includes: a data temporary storage processing function that temporarily store-processes the time-series data received by the data input means, over time at each preset unit time point; a fluctuation permission determination function that determines whether or not each time-series data deviates from a fluctuation permission range set on the basis of time-series data within a past fixed period based on a time point immediately preceding an input time point of each time-series data using the temporarily store-processed data; a learning data extraction function that, when deviation from the fluctuation permission range is determined, continuously extracts time-series data concerning the determination as additional learning data necessary for predicting the subsequent data concentration; and a learning data storage processing function that collectively store-processes the continuously extracted additional learning data in the data storage means; a prediction processing function that predicts the data concentration on the basis of a data structure of time-series data specified by the collectively stored additional learning data and existing learning data, these respective information processing functions being implemented by a computer provided in the data concentration prediction means.

### Advantageous Effects of Invention

As described above, the present invention has employed the structure in which the learning data extraction processing unit effectively functions when continuously extracting significant additional learning data from received time-series data, and then, through analytical processing based on the extracted additional learning data and existing learning data, the prediction processing unit predicts subsequent data concentration. Thus, the structure can provide an excellent data concentration prediction device that can accurately predict in real-time, particularly, subsequent data concentration in time-series data, a method thereof, and a program thereof.

### BRIEF DESCRIPTION OF DRAWINGS

FIG. 1 is a block diagram depicting a structure of a data concentration prediction device according to a first exemplary embodiment of the present invention;

FIG. 2 is a flowchart depicting an operation of extraction processing of learning data and calculation processing based on the learning data by the data concentration prediction device disclosed in FIG. 1;

FIG. 3 is a flowchart depicting an operation for predicting future data concentration by the data concentration prediction device disclosed in FIG. 1;

FIG. 4 is an illustrative view depicting an example of latest past U time points as a reference used when calculating a fluctuation permission range by the data concentration prediction device disclosed in FIG. 1;

FIG. 5 is an illustrative view depicting an example of learning data and an effective learning period extracted by the data concentration prediction device disclosed in FIG. 1;

FIG. 6 is a block diagram depicting a structure of a data concentration prediction device according to a second exemplary embodiment of the present invention;

FIG. 7 is a flowchart depicting an operation of extraction processing of learning data and calculation processing based on the learning data by the data concentration prediction device disclosed in FIG. 6;

FIG. 8 is a flowchart depicting a processing operation for predicting the number of future postings by the data concentration prediction device disclosed in FIG. 6; and

FIG. 9 is an illustrative view depicting an example of calculation of influence based on a relationship between nodes and groups.

### DESCRIPTION OF EMBODIMENTS

### First Exemplary Embodiment

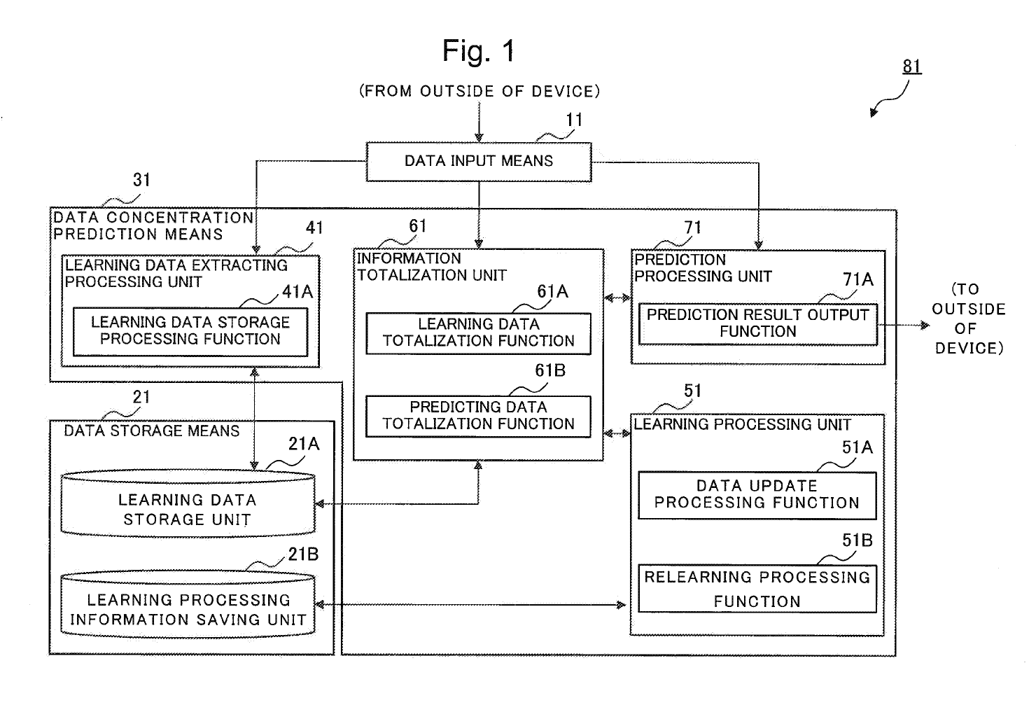

A data concentration prediction device according to a first exemplary embodiment of the present invention will be described with reference to FIGS. 1 to 5.

### (Whole Structure)

In the present first exemplary embodiment, a reference sign 81 depicted in FIG. 1 denotes a data concentration prediction device that extracts a characteristic point of time-series data received from outside and, based on the point, predicts subsequent data concentration.

The data concentration prediction device 81 includes a data input means 11, a data storage means 21, and a data concentration prediction means 31. The data input means 11 receives data transmitted from a plurality of nodes together with corresponding attribute information to input as time-series data. The data storage means 21 stores the received time-series data. The data concentration prediction means 31 analyzes a data structure of the stored time-series data to predict subsequent data concentration.

Herein, the nodes (transmission sources) represent individual elements forming a network. In a computer network, the nodes represent servers, clients, hubs, routers, access points, or the like, and, in a sensor network, the nodes represent sensor terminals. In addition, data for which data concentration is predicted is assumed to be among various kinds of data, such as information detected by various kinds of sensors, the number of postings on blogs or Twitter, response speeds indicating intensities of shaking of an earthquake, or power consumption in daily life.

The data concentration prediction means 31 includes a learning data extraction processing unit 41. The learning data extraction processing unit 41 temporarily store-processes the time-series data received by the data input means 11 over time at each preset unit time point (unit totalization time). In addition to that, on the basis on time-series data within a fixed period using the temporarily store-processed data, the learning data extraction processing unit 41 continuously extract-processes the time-series data deviating from a fluctuation permission range preset on the basis on time-series data within a fixed period using the temporarily store-processed data, as additional learning data necessary for predicting subsequent data concentration. Herein, within a fixed period means within a past fixed period based on a time point immediately preceding an input time of each time-series data.

In addition, the data storage means 21 includes a learning data storage unit 21A and a learning processing information saving unit 21B. The learning data storage unit 21A stores additional learning data continuously extracted by the learning data extraction processing unit 41. The learning processing information saving unit 21B stores result information of various calculation processes performed by the data concentration prediction means 31 on the basis of the stored additional learning data.

The learning data extraction processing unit 41 includes a learning data storage processing function 41A that collectively store-processes additional learning data exhibiting a distinctive behavior as compared to a fluctuation tendency of continuously extracted latest past plural time points, in the learning data storage unit 21A. The additional learning data includes also time-series data at time points therearound when needed for learning.

Specifically, the learning data storage processing function 41A is structured so as not to perform storage processing into the learning data storage unit 21A during a period in which the determination of deviation from the fluctuation permission range (a specific description of the determination will be given later) continues, and to perform storage processing collectively at one time when the determination of deviation from the fluctuation permission range stops. This structure allows the learning data extraction processing unit 41 to extract, as an effective learning period, a period during which effective additional learning data continuously appears.

The data concentration prediction means 31 includes an information totalization unit 61 that correlates prediction attribute information (attribute data concerning prediction of data concentration) included in time-series data with a unit time point to totalize as totalization data. Herein, the prediction attribute information means information concerning an attribute for which future data concentration is desired to be predicted, among attributes included in time-series data.

The information totalization unit 61 includes a learning data totalization function 61A and a prediction data totalization function 61B. The learning data totalization function 61A correlates prediction attribute information included in the additional learning data collectively stored in the learning data storage unit 21A with a unit time point to totalize as learning totalization data. In response to a prediction request issued at a preset time interval (prediction interval) by an external input, the prediction data totalization function 61B correlates prediction attribute information included in time-series data received by the data input means 11 with a unit time point to totalize as prediction totalization data. Additionally, information concerning the prediction interval preset by the external input is assumed to be stored in the data storage means 21. The present first exemplary embodiment is adapted such that a prediction processing unit 71 acquires the information concerning the prediction interval from the data storage means 21 and also, in accordance with the information, issues a prediction request to the data input means 11.

In addition, the data concentration prediction means 31 includes a learning processing unit 51 and the prediction processing unit 71. The learning processing unit 51 calculates influence data indicating an influence of each node on a prediction value concerning data concentration in a relationship with the learning totalization data output from the learning data totalization function 61A. In addition to that, the learning processing unit 51 saves the influence data and the learning totalization data used for the calculation in the learning processing information saving unit 21B. The prediction processing unit 71 calculates a prediction value of the prediction attribute information on the basis of the prediction totalization data totalized by the prediction data totalization function 61B and the influence data calculated by the learning processing unit 51.

The prediction processing unit 71 includes a prediction result output function 71A that transmits a prediction result to an outside of the device. Furthermore, the prediction processing unit 71 may be adapted to store-process the calculated prediction value in the data storage means 21.

The learning processing unit 51 further includes a data update processing function 51A and a relearning processing function 51B. When, at the time of calculation of influence data in real-time, previously saved influence data and learning totalization data are present in the learning processing information saving unit 21B, the data update processing function 51A updates the saved information in the learning processing information saving unit 21B by the influence data calculated in real-time and learning totalization data used for the calculation. The relearning processing function 51B combines the learning totalization data previously saved in the learning processing information saving unit 21B with learning totalization data acquired in real-time from the information totalization unit 61 and also calculates influence data using the combined data.

The learning data extraction processing unit 41 is adapted, as described above, as follows. Firstly, when extracting additional learning data, the learning data extraction processing unit 41 divides time-series data received from the data input means 11 by each unit time point to temporarily store in a volatile memory (not shown) (data temporary storage processing function). Second, based on that, the learning data extraction processing unit 41 calculates a fluctuation permission range for prediction attribute information included in time-series data of time points in real-time.

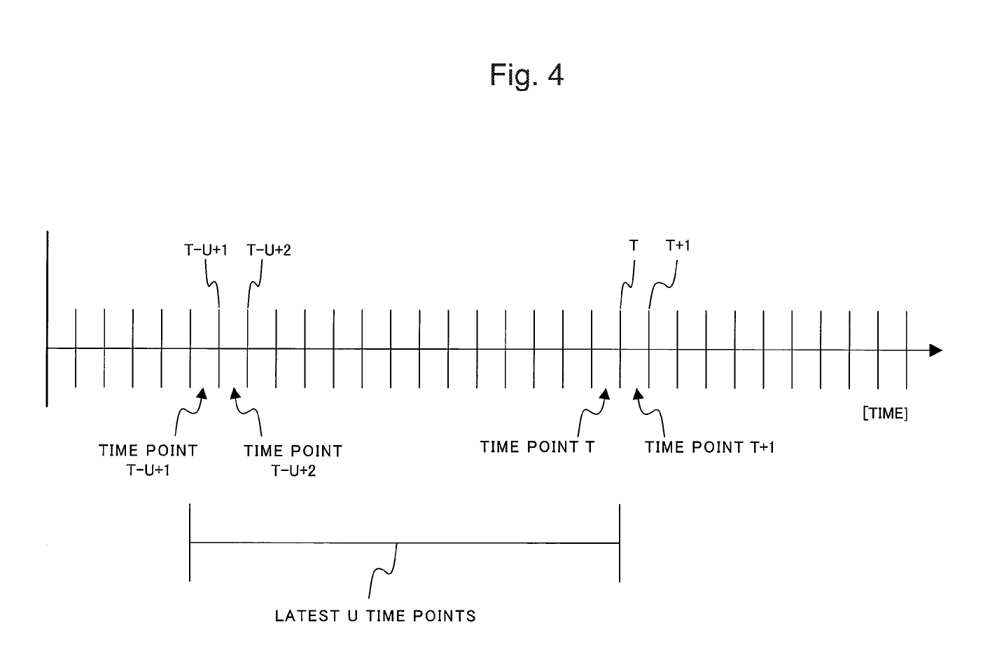

In the present first exemplary embodiment, it is adapted such that the above fluctuation permission range is calculated and set by the learning data extraction processing unit 41 on the basis of a mean value and variance of prediction attribute information included in time-series data within a past fixed period seen from an input time point of each time-series data. Hereinbelow, with reference to FIG. 4, a description will be given of a method for calculating the above-described fluctuation permission range by the learning data extraction processing unit 41.

As described in FIG. 4, the horizontal axis representing time is divided into unit time points (unit totalization times), and for example, a time point between T and T+1 represents time point T+1. Herein, when a time point to which a present point in time belongs (a current time point) is assumed to be a time point T, the learning data extraction processing unit 41 specifies, as a past fixed period, total U time points (latest past U time points: T−U+1, . . . , and T) continuing back from the time point T. Then, the learning data extraction processing unit 41 calculates a fluctuation permission range determined by ‘mean value±α×standard deviation (a positive square root of variance)’ on the basis of a mean value and variance of prediction attribute information included in time-series data transmitted within the latest past U time points (α: sensitivity to deviation).

Herein, the sensitivity α as an externally input parameter is an important element of the above expression and thus greatly influences on the extraction of additional learning data, so that the sensitivity α also greatly influences on accuracy of data concentration prediction performed on the basis of the additional learning data. Accordingly, the present first exemplary embodiment has been adapted to separately calculate a plurality of temporary prediction values on the basis of temporarily set some α values and employ an α value corresponding to a temporary prediction value exhibiting the highest prediction accuracy from among the plurality of temporary prediction values. The temporary prediction values herein may be calculated using time-series data store-processed in the past.

The learning data extraction processing unit 41 is adapted to determine whether or not prediction attribute information at a time point in real-time deviates from the fluctuation permission range calculated by the above method (fluctuation permission determination function). In other words, the learning data extraction processing unit 41 is adapted to determine that the prediction attribute information at a time point in real-time does not deviate from the fluctuation permission range when it is within the range, and determine that the prediction attribute information deviates from the fluctuation permission range when it is out of the range.

The learning data extraction processing unit 41 is adapted, after having determined that the prediction attribute information deviates from the fluctuation permission range, to extract time-series data concerning the determination as additional learning data. The extraction herein indicates that the learning data extraction processing unit 41 allows the time-series data concerning the determination (including also time-series data of the neighboring time points when needed for learning) to be distinguished from other time-series data than that.

In addition, the learning data extraction processing unit 41 continuously performs the determination of the deviation as long as extraordinary data due to a sudden machine trouble or the like does not appear, from the structure of the above expression ‘mean value±α×standard deviation’. Accordingly, the time-series data concerning the determination is continuously extracted by the learning data extraction processing unit 41.

Specifically, the learning data extraction processing unit 41 is adapted, under a specific condition, to output time-series data corresponding to continuous B time points collectively at one time when determination at a time point T+B+1 ends (in the above example, the time-series data is not output by dividing into B batches at each unit time point). The specific condition represents a condition in which, in a case where deviation is determined at all of the continuous B time points, non-deviation is determined at time points up to the time point T and time points after the time point T+B+1. Herein, the continuous B time points represent a total of B time points T+1, . . . , T+B continuing from a certain time point T+1.

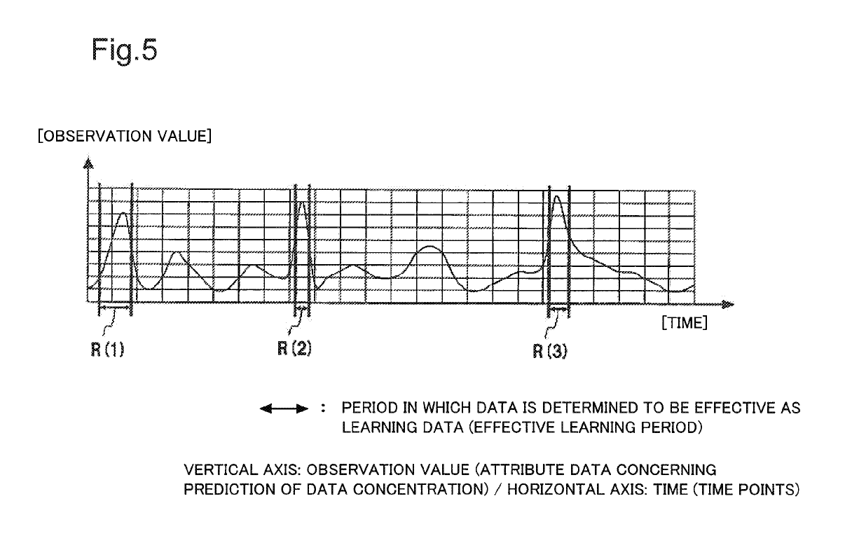

(Effective Learning Period) Hereinbelow, an effective learning period extracted by the learning data extraction processing unit 41 will be described on the basis of a graph (an extraction image of an effective learning period based on a mean value and variance) exemplified in FIG. 5.

In the graph depicted in FIG. 5, the horizontal axis represents time (time point) and the vertical axis represents prediction attribute information (attribute data concerning prediction of data concentration) as observation value. The observation value is assumed to represent a variety of data such as response speeds indicating shaking intensities of an earthquake, information on measurement by various kinds of sensors, numbers of postings on the Twitter and blogs, or power consumption in daily life.

As depicted in FIG. 5, intervals between thick lines: ‘R(1), R(2), and R(3)’ represent effective learning periods that are continuing periods of time points at which an observation value at each time point deviates from the fluctuation permission range (time points at which the observation value has significantly changed from a mean value of latest past plural time points).

In the method of extraction by the learning data extraction processing unit 41 described above, ranges partitioned by the effective learning periods flexibly change depending on a state of fluctuation of the waveform, as in the R(1), the R(2), and the R(3) depicted in FIG. 5. Accordingly, the learning data extraction processing unit 41 can accurately extract additional learning data for prediction of subsequent data concentration within a necessary-sufficient range.

In addition, the effective learning periods change depending on the fluctuation permission range determined by the above-mentioned ‘mean value±α×standard deviation’ concerning observation values in the past fixed period. Then, specifically, the effective learning periods change depending on ‘to what extent past time points are regarded as the latest time points (a range of the past fixed period)’ and ‘a magnitude of the sensitivity (α) to deviation’. In other words, changing the value of U and the value of α allows the learning data extraction processing unit 41 to extract additional learning data needed as appropriate over the all regions of the flexible effective learning periods.

### (Pre-Processing)

Hereinbelow, a description will be given of pre-processing executed by the learning processing unit 51 described above.

The pre-processing refers to saving of data resulting from subjecting original data obtained by a calculation process and the like to process(es) (pre-processing data) so that efficient relearning (such as calculation of influence data) can be realized when new additional learning data is extracted and added by the learning data extraction processing unit 41.

For example, in learning of a regression analysis model as a typical mathematical model, there can be obtained a regression coefficient as the result of learning. In a process for acquiring the learning result, employing a structure of saving values of an objective variable (a vector) and explanatory variables (a matrix) resulting from subjecting the original data to process(es) allows efficient relearning using existing pre-processing data in subsequent learning steps (learning phases).

The data concentration prediction device 81 according to the present first exemplary embodiment is adapted, when the learning processing unit 51 has calculated influence data, to save the influence data and learning totalization data used for the calculation as pre-processing data in the learning processing information saving unit 21B, as depicted in FIG. 1. In addition, the data concentration prediction device 81 is adapted, when the pre-processing data is previously saved in the learning processing information saving unit 21B, to update the saved information as pre-processing data by the data update processing function 51A. The pre-processing data thus saved or updated is used when calculating influence data by the relearning processing function 51B, as described above.

By doing this, calculation for the pre-processing data can be omitted when extracted and added new additional learning data is corresponding to existing pre-processing data, as a result of which calculation time necessary for relearning can be shortened.

### (Description of Operation)

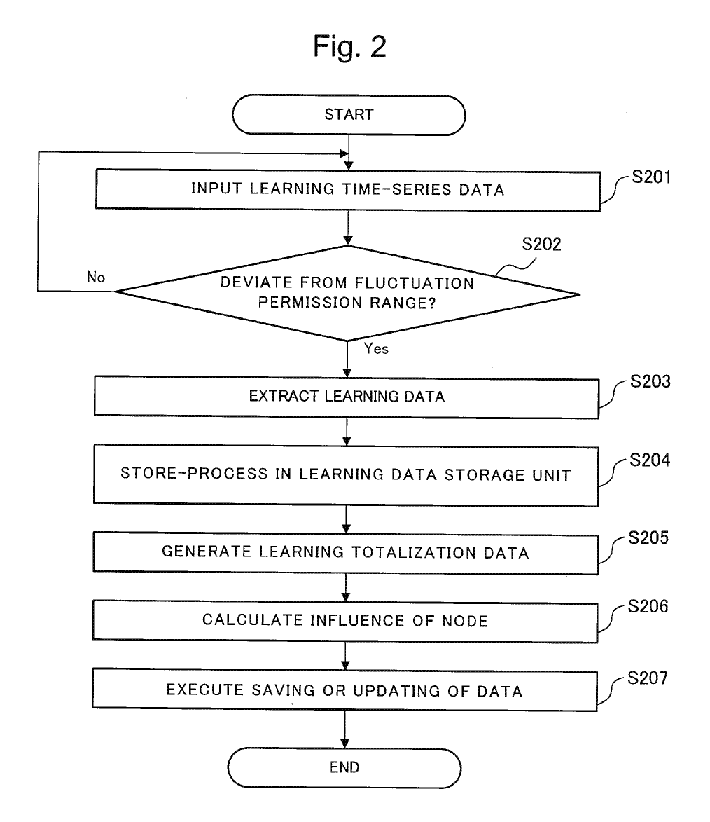

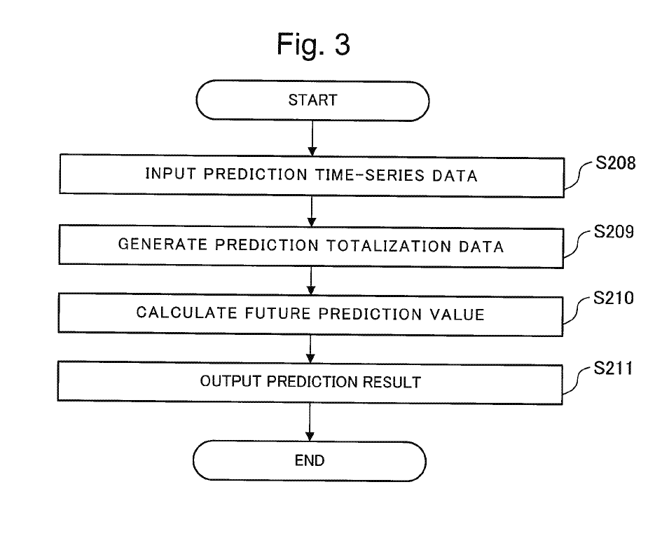

Next, operation control of the data concentration prediction device 81 depicted in FIG. 1 will be described on the basis of a flowchart depicted in FIG. 2 or 3.

### (Learning Processing)

Firstly, a description will be given of learning processing of time-series data on the basis of FIG. 2. The data input means 11 is input time-series data from the outside of the device and transmits the time-series data to the learning data extraction processing unit 41 (FIG. 2: S201).

Next, the learning data extraction processing unit 41 calculates a fluctuation permission range to determine whether or not prediction attribute information included in time-series data at a time point in real-time deviates from the fluctuation permission range (FIG. 2: S202). The fluctuation permission range is a fluctuation permission range in accordance with a latest fluctuation tendency of the prediction attribute information included in the time-series data received from the data input means 11

For example, when an observation value (prediction attribute information) at the time point T+1 as a time point immediately after a current time point is obtained, the learning data extraction processing unit 41 determines, when the observation value is out of a range specified by the ‘mean value±α×standard deviation’ at the latest past U time points, that the prediction attribute information deviates from the fluctuation permission range (deviates from the tendency of the latest past U time points) (FIG. 2: YES in S202). In addition to that, the learning data extraction processing unit 41 extracts time-series data concerning the determination as additional learning data and moves to determination processing for subsequent time-series data (FIG. 2: S203). At this time, when needed for learning, the learning data extraction processing unit 41 also extracts together time-series data around the time points concerning the determination (FIG. 2: S203).

On the other hand, when the observation value at the time point T+1 is within the range determined by ‘mean value±α×standard deviation’ in the latest past U time points, the learning data extraction processing unit 41 determines that the prediction attribute information does not deviate from the fluctuation permission range (follows the tendency of the latest past U time points). Then, without extracting time-series data concerning the determination, the learning data extraction processing unit 41 moves to determination processing for subsequent time-series data (FIG. 2: NO in S202).

In the present first exemplary embodiment in which the respective step contents up to the above extraction processing (FIG. 2: S201 to S203) are repeated over time (T+1, T+2, T+3, . . . ), an observation value deviating from the fluctuation permission range continuously appears as long as any extraordinary data due to a sudden machine trouble or the like does not appear, from the structure of the expression: ‘mean value±α×standard deviation’. Accordingly, the learning data extraction processing unit 41 can continuously extract characteristic time-series data as additional learning data, consequently allowing extraction of an effective learning period as a period during which effective learning data continuously appears.

Next, the learning data extraction processing unit 41, which has continuously determined that an observation value at a time point in real-time deviates from the fluctuation permission range and has continuously extracted time-series data concerning the determination, collectively store-processes the pieces of time-series data in the learning data storage unit 21A (FIG. 2: S204). The time-series data is time-series data (including time-series data at the neighboring time points when needed for learning) extracted when time-series data not deviating from the fluctuation permission range has appeared.

Next, the information totalization unit 61 correlates the prediction attribute information included in the additional learning data collectively stored in the learning data storage unit 21A with a unit time point to totalize as learning totalization data, and also transmits the learning totalization data to the learning processing unit 51 (FIG. 2: S205).

Next, the learning processing unit 51 calculates influence data indicating influence of each node on data concentration in a relationship with the learning totalization data received from the information totalization unit 61 (FIG. 2: S206). In addition to that, the learning processing unit 51 save-processes the influence data and the learning totalization data used for the calculation in the learning processing information saving unit 21B (FIG. 2: S207).

Herein, when already saved influence data and learning totalization data are present in the learning processing information saving unit 21B, the learning processing unit 51 causes the data update processing function 51A to update the saved information in the learning processing information saving unit 21B (FIG. 2: S207). In this case, the data update processing function 51A updates the saved information in the learning processing information saving unit 21B by influence data calculated in real-time and learning totalization data used for the calculation.

In addition, when saved or updated learning totalization data is present in the learning processing information saving unit 21B, the learning processing unit 51 causes the relearning processing function 51B to calculate influence data (FIG. 2: S206). In this case, the relearning processing function 51B combine-processes the saved learning totalization data with learning totalization data acquired from the information totalization unit 61 in real-time, and calculate influence data using the combine-processed data. Similarly to the above, the learning processing unit 51 causes the data update processing function 51A to update the saved information in the learning processing information saving unit 21B by the influence data and the learning totalization data used for the calculation (FIG. 2: S207).

Herein, additional learning data obtained by extraction processing of the learning data extraction processing unit 41 described above is sometimes limited to time-series data corresponding to time points exhibiting a particularly distinctive behavior as compared to the tendency of the latest past plural time points. Accordingly, for example, when it is necessary to extract all pieces of knowledge regardless of the extent of data fluctuation, the extraction processing may not be executed or may be controlled by adjustment of the parameter(s) (U, α), or the like.

In addition, the learning data extraction processing unit 41 may be adapted, when a time point concerning the determination of the deviation is only a single time point or the number of time points concerning the determination thereof does not exceed a preset number of continuing time points, not to store-process time-series data concerning the determination in the learning data storage unit 21A. In other words, the learning data extraction processing unit 41 may be adapted to store-process time-series data as additional learning data only when it performs the determination of deviation from the fluctuation permission range at time points continuing to some extent (within a certain length of period). This allows elimination of data without significance resulting from a sudden machine trouble or the like, so that accuracies of determination and subsequent prediction can be improved.

### (Prediction Processing)

Next, a description will be given of prediction processing of data concentration on the basis of FIG. 3.

The data input means 11 receives time-series data for predicting data concentration in response to a prediction request issued at a preset time interval (prediction interval) and also transmits the input time-series data to the information totalization unit 61 (FIG. 3: S208). Subsequently, the information totalization unit 61 causes the prediction data totalization function 61B to correlate prediction attribute information included in the time-series data received from the data input means 11 with a unit time point to totalize as prediction totalization data, and also transmits the prediction totalization data to the prediction processing unit 71 (FIG. 3: S209).

Next, the prediction processing unit 71 that has received the prediction totalization data calculates a prediction value concerning data concentration on the basis of the prediction totalization data and the influence data calculated by the learning processing unit 51. At that time, when needed, the prediction processing unit 71 store-processes the calculated prediction value in the data storage means 21 (FIG. 3: S210). The prediction processing unit 71 causes the prediction result output function 71A to transmit a prediction result to the outside of the device (FIG. 3: S211).

The content executed at each step in the above respective steps S201 to S211 (FIGS. 2 and 3) may be programmed, as well as the series of respective control programs may be realized by a computer.

### Advantageous Effects of First Exemplary Embodiment

The first exemplary embodiment has employed the structure in which distinctive time-series data is extracted on the basis of the fluctuation tendency of a past observation value (prediction attribute information). This structure allows automatic extraction of data within a necessary- and sufficient range adapted to various fluctuation tendencies of the observation value. In other words, as depicted in FIG. 5, the learning data extraction processing unit 41 can automatically extract additional learning data over the all regions of the effective learning periods adapted to a width and an inflection of the waveform. This allows automatic avoidance of a situation such as an excessive data collection or a shortage of necessary data.

In this way, the learning data extraction processing unit 41 can effectively extract useful knowledge concerning a time point indicating a distinctive behavior, for example, such as breakdown of an automobile or flaming on the Twitter or blogs (a situation in which a large number of viewers intensively post comments in response to descriptions on blogs or the like). This allows data concentration to be accurately predicted using the extracted data.

### Second Exemplary Embodiment

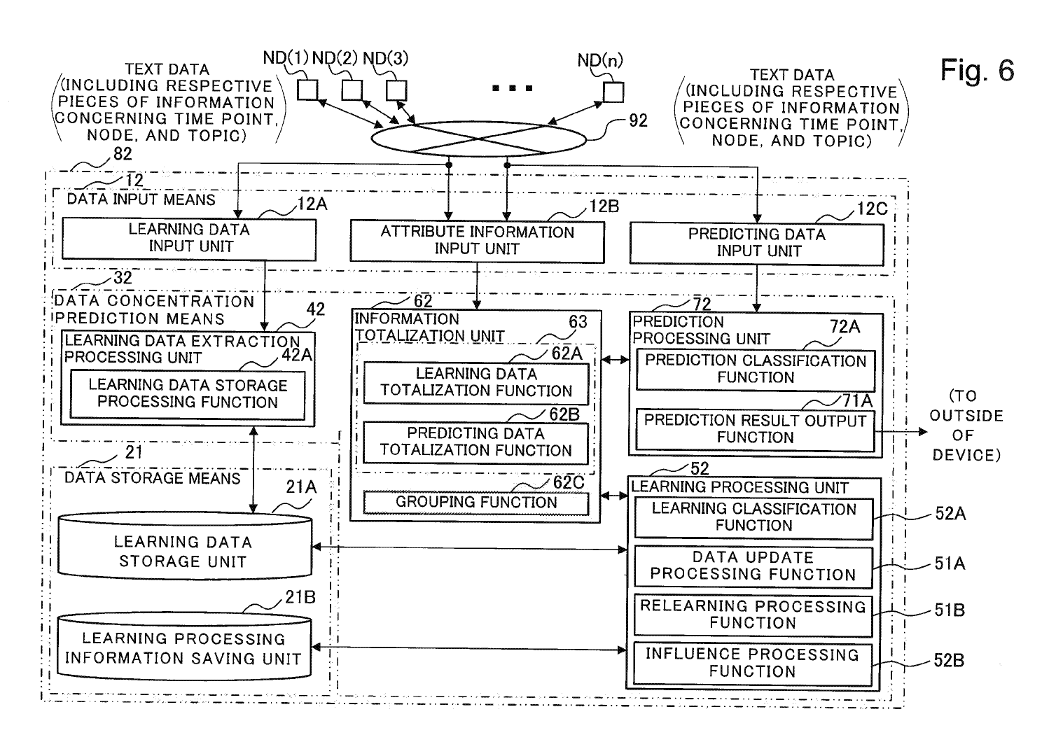

A data concentration prediction device according to a second exemplary embodiment of the present invention will be described on the basis of FIGS. 6 to 9.

Herein, the same reference signs are given to the same constituent members as those in the first exemplary embodiment described above. In the second exemplary embodiment, as a specific example, text data posted on the Twitter (registered trademark) is an analysis target, and a description will be given of a structure and an operation for predicting the number of future postings concerning a designated topic (a sum of the number of times of tweets).

In other words, the second exemplary embodiment exemplifies a case in which the number of postings is employed as prediction attribute information (data of an attribute concerning the prediction of data concentration) to predict the numbers of postings at S time points ahead as seen from a specific time point in real-time. In addition, a topic (or possibly a plurality of topics) for which the number of future postings is desired to be predicted is assumed to be previously designated by an external input or the like.

### (Whole Structure)

The data concentration prediction device 82 according to the second exemplary embodiment includes, a data input means 12, a data storage means 21, and a data concentration prediction means 32, as depicted in FIG. 6. The data input means 12 receives Twitter data transmitted from users (senders) as a plurality of nodes ND (1 to n) together with corresponding attribute information via a network 92 and inputs as time-series data. The data storage means 21 stores the received time-series data. The data concentration prediction means 32 analyzes a data structure of the stored time-series data to predict subsequent data concentration.

The Twitter data herein means text data tweeted (posted) on the Twitter and each piece of information input simultaneously with the text data (each piece of information concerning ‘tweet time point’, ‘a node that tweeted’, and ‘a topic to which the text data belongs’).

The data input means 12 includes a learning data input unit 12A, an attribute information input unit 12B, and a prediction data input unit 12C. The learning data input unit 12A is input, over time, Twitter data for extracting learning data. The attribute information input unit 12B is input attribute information of each node linked with each Twitter data. The prediction data input unit 12C is input Twitter data (prediction data) for predicting data concentration in response to a prediction request issued at a preset time interval (prediction interval).

Herein, the attribute information input unit 12B is adapted to acquire, as attribute information of a node, pieces of information such as a Twitter client of each node, the number of times of tweets within an effective learning period, a mean value of each of the number of comments, the number of trackbacks, the number of replies, and the number of retweets within the effective learning period, the number of follows within the effective learning period, and a maximum value of the number of followers.

The data concentration prediction means 32 includes a learning data extraction processing unit 42. The learning data extraction processing unit 42 divides the Twitter data received by the data input means 12A into data at each preset unit time point (unit totalization time) and temporarily store-processes the data over time. In addition to that, the learning data extraction processing unit 42 continuously extract-processes the Twitter data deviating from the fluctuation permission range preset on the basis of Twitter data within a part fixed period using the temporarily store-processed data, as additional learning data necessary for predicting subsequent data concentration. Herein, the past fixed period is a past fixed period based on a time point immediately preceding an input time point of each Twitter data.

The data storage means 21 is configured by a structure that includes a learning data storage unit 21A and a learning processing information saving unit 21B. The learning data storage unit 21A stores additional learning data continuously extracted by the learning data extraction processing unit 42. The learning processing information saving unit 21B stores pieces of result information of various calculation processes performed by the data concentration prediction means 32 on the basis of the stored additional learning data. The learning data extraction processing unit 42 includes a learning data storage processing function 42A that collectively store-processes the continuously extracted data in the learning data storage unit 21A.

In addition, the data concentration prediction means 32 includes a learning processing unit 52, an information totalization unit 62, and a prediction processing unit 72. The learning processing unit 52 calculate-processes influence data indicating an influence of each node on data concentration by a calculation function adopting a regularization approach that prevents overfitting on the basis of additional learning data acquired from the learning data storage unit 21A. The information totalization unit 62 executes data totalization processing by using attribute information of each node acquired from the attribute information input unit 12B. The prediction processing unit 72 predicts data concentration on the basis of prediction data that the prediction data input unit 12C receives over time in response to a prediction request issued at a preset time interval (prediction interval).

Herein, the influence of a node means an influence that the node has on a prediction value of data concentration. In other words, the influence data is data that indicates to what extent each node has contributed to concentrated transmission of data at time points around a time point of the concentrated transmission of data. In addition, information concerning a prediction interval preset by an external input is assumed to be stored in the data storage means 21. In the present second exemplary embodiment, it is adapted such that the prediction processing unit 72 acquires the information concerning the prediction interval from the data storage means 21 and, according to the information, issues a prediction request to the data input means 12.

The learning processing unit 52 includes a learning classification function 52A. The learning classification function 52A classifies the text data included in the additional learning data acquired from the learning storage unit 21A into each topic to generate learning classification information of each topic (node information, time point information, and text data of Twitter data belonging to the each topic). Additionally, the prediction processing unit 72 includes a prediction classification function 72A. The prediction classification function 72A classifies the prediction data received by the prediction data input unit 12C over time in response to a prediction request issued at the above-described prediction interval into each topic to generate prediction classification information of each topic (node information, time point information, and text data of Twitter data belonging to the topic).

The information totalization unit 62 includes a grouping function 62C. The grouping function 62C executes creation of groups (grouping) of all nodes on the basis of learning classification information generated by the learning processing unit 52 or prediction classification information generated by the prediction processing unit 72 and attribute information of each node acquired from the attribute information input unit 12B to generate group information (information concerning a group to which each node belongs).

In addition, the information totalization unit 62 includes a learning data totalization function 62A and a prediction data totalization function 62B that generates cross-totalization data as prediction totalization data by correlating the group information generated by the grouping function 62C using the prediction classification information with a unit time point. The learning data totalization function 62A generates cross-totalization data (a cross-totalization table of the numbers of tweets concerning group and time point information of each topic) as learning totalization data by correlating the group information generated by the grouping function 62C using the prediction classification information with unit time point. The prediction data totalization function 62B generates cross-totalization data as learning totalization data by correlating the group information generated by the grouping function 62C using the prediction classification information with the unit time point. Herein, the learning data totalization function 62A and the prediction data totalization function 62B included in the information totalization unit 62 are collectively referred to as a group totalization function 63.

The learning processing unit 52 is adapted to perform the calculation of the influence data described above on the basis of learning totalization data obtained from totalization by the learning data totalization function 62A.

In addition, the prediction processing unit 72 is adapted to execute the prediction of data concentration described above on the basis of the prediction totalization data obtained from the totalization by the prediction data totalization function 62B and the influence data calculated by the learning processing unit 52, thereby performing a calculation process of a prediction value of the number of future postings (a prediction value concerning subsequent data concentration). The prediction processing unit 72 includes a prediction result output function 71A that outputs the calculated prediction value of the number of future postings to the outside of the device. In addition, the prediction processing unit 72 may be adapted to store-process the prediction value concerning the calculation in the data storage means 21.

The grouping of each node described above is performed for each kind of attributes, such as ‘What is the Twitter client?’ ‘Which is the number of times of tweets within a learning period: 1 to 100 times, 101 to 1000 times, or 1001 times or more?’, and ‘Which is a maximum value of the number of followers within the learning period: 1 to 1000 times or 1001 times or more?’.

Additionally, the group information represents information indicating that grouping has been determined based on commonality between the attributes of respective nodes and the respective nodes have been made to belong to one or more groups.

Particularly, when the number of nodes is unstable, limiting the number of groups to a specific number allows the respective nodes to be made to belong to these groups (since limiting the number thereof to a specific one has substantially the same meaning as reduction and stabilization of the number of nodes). By doing this, processing using a statistical method such as regression analysis can be performed rapidly and highly accurately. In other words, in the second exemplary embodiment, grouping can stabilize learning results of the influences of nodes.

Furthermore, when necessary, final group information may be generated on the basis of a product set of the results of grouping performed for each kind of attributes. In addition, as for a node whose number of times of tweets is not less than a fixed value, grouping may be performed by defining the node itself as a single group. This allows an appropriate grasp of information on a node particularly influential on the Twitter.

In addition, the learning processing unit 52 includes a function that save-processes influence data calculated in real-time and, as pre-processing data, information (totalization data processed information) resulting from subjecting processing learning totalization data used for the calculation to process, in the learning processing information saving unit 21B. In addition to that, the learning processing unit 52 includes a data update processing function 51A that, when the pre-processing data is already saved, updates the saved information as the pre-processing data in the learning processing information saving unit 21B by influence data calculated in real-time and totalization data processed information concerning the calculation. Furthermore, the learning processing unit 52 includes a relearning processing function 51B and an influence processing function 52B. In the case where pre-processing data is already saved as above, when calculating influence in real-time, the relearning processing function 51B performs combining processing of the saved past totalization data processed information with totalization data processed information in real-time, and calculates influence data using the combined information. Based on the calculated influence of group, the influence processing function 52B uses a sum of influences in each group to which each node belongs as an influence of the each node to calculate influence data concerning the node.

Hereinbelow, a description will be given of a content of information processing by the data concentration prediction device 82 by setting the number of groups to a fixed number G and referring to Expressions (there will be disclosed a technique for calculating influence data by a statistical method to predict subsequent data concentration, and the like).

The learning data extraction processing unit 42 is adapted as follows. Firstly, the learning data extraction processing unit 42 calculates a fluctuation permission range determined for each time point on the basis of Twitter data received from the learning data input unit 12A and temporarily stored in a volatile memory, by Expressions 1 and 2 below. Secondly, the learning data extraction processing unit 42 continuously determines whether or not the number of times of all tweets (the number of postings) as prediction attribute information at time points in real-time deviates from the fluctuation permission range.

$$\begin{matrix}[ Equation 1 ] & \\ {\hat{μ}}_{{T}^{′} + 1} + α {\hat{σ}}_{{T}^{′} + 1} < {y}_{{T}^{′} + 1} & ( 1 ) \\ [ Equation 2 ] & \\ {\hat{μ}}_{{T}^{′} + 1} = \frac{1}{U} {\sum }_{u = 1}^{U} {y}_{{T}^{′} - U + u} , \\ {\hat{σ}}_{{T}^{′} + 1}^{2} = \frac{1}{U} {\sum }_{u = 1}^{U} {( {y}_{{T}^{′} - U + u} - {\hat{μ}}_{{T}^{′} + 1} )}^{2} & ( 2 )\end{matrix}$$

The above Expressions 1 and 2 are used as indicators for evaluating appropriateness, as additional learning data (learning data necessary for predicting subsequent data concentration), of Twitter data observed at a time point T′+1 (a time point in real-time).

Herein, y_{T′+1} represents a sum of the numbers of tweets (the number of postings) concerning all nodes at the time point T′+1 and,

\hat{μ}_{T′+1} and \hat{σ}_{T′+1} (a positive square root of variance \hat{Γ}_{T′+1}²)

represent a mean value and a standard deviation calculated on the basis of the number of tweets at total U time points (latest past U time points) continuing back from the time point T′, as depicted in the Expression 2. In addition, U and α that is sensitivity to deviation are parameters input from outside.

In addition, in order to focus on increase in the number of postings herein, a structure has been employed in which the learning data extraction processing unit 42 extracts, as additional learning data, Twitter data concerning a number of postings ‘y_{T′+1}’ deviating to a larger side from a fluctuation permission range indicated on a left side of the Expression 1.

In other words, the learning data extraction processing unit 42 is adapted as follows. Firstly, the learning data extraction processing unit 42 determines that Twitter data is inappropriate as additional learning data when the number of postings at a time point in real-time is within a fluctuation permission range based on a mean value of the numbers of postings within a past fixed period (latest past U time points) (unless satisfies the Expression 1). Secondly, the learning data extraction processing unit 42 determines that Twitter data is appropriate as additional learning data when the number of postings at a time point in real-time deviates from the fluctuation permission range (if satisfies the Expression 1).

Herein, the data concentration prediction device 82 is adapted such that, on the basis of Twitter data as additional learning data extracted by the learning data extraction processing unit 42, the prediction processing unit 72 finally calculates a prediction value of the number of future postings. Accordingly, prediction accuracy significantly depends on the sensitivity c′ (Expression 1) to deviation used for extracting additional learning data. Thus, even in the second exemplary embodiment, learning processing and prediction processing have been executed with respect to some patterns of the value α by using previously stored past data, and a value of α exhibiting a highest prediction accuracy has been used in the above Expression 1 to improve prediction accuracy. In addition, as an evaluation indicator for determining the value of α, a mean squared error has been employed.

In addition, the learning data extraction processing unit 42 is adapted, when it determines that Twitter data concerning the time point T′+1 is appropriate as additional learning data, to extract the Twitter data concerning the time point T′+1 of the determination together with Twitter data concerning latest past S time points (T′+1−S, T′+2−S, . . . T′+1−1) necessary for learning.

Furthermore, from the structures of the above Expressions 1 and 2, the learning data extraction processing unit 42 is adapted as follows. Firstly, the learning data extraction processing unit 42 continuously performs the determination of being appropriate as additional learning data as long as extraordinary data does not appear. Secondly, the learning data extraction processing unit 42 store-processes, as additional learning data, Twitter data concerning time points exhibiting a larger increase than the numbers of postings at latest past plural time points (including Twitter data concerning latest past S time points), collectively at one time in the learning data storage unit 21A.

The learning data totalization function 62A is adapted as follows. Firstly, the learning data totalization function 62A totalizes the number of times of tweets at each time point and in each group on the basis of the learning classification information acquired from the learning processing unit 52 and the group information corresponding thereto input from the grouping function 62C. Secondly, the learning data totalization function 62A generates learning totalization data (cross-totalization data) represented by a determinant 3 below.

$$\begin{matrix}[ Equation 3 ] & \\ X = ( \begin{matrix} {x}_{11} & {x}_{12} & … & {x}_{1 G} \\ {x}_{21} & {x}_{22} & … & {x}_{2 G} \\ ⋮ & ⋮ & ⋮ & ⋮ \\ {x}_{T 1} & {x}_{T 2} & … & {x}_{TG}\end{matrix} ) & ( 3 )\end{matrix}$$

in which t=1, 2, . . . , T, and g=1, 2, . . . , G.

In a matrix shown in the Expression (3), each column represents each time point, and each row represents each group. In addition, values of respective elements x_{tg} represent the number of postings at each time point, and a sum of the numbers of times of tweets in each group is organized for each time point.

In other words, the learning data totalization function 62A is adapted to generate learning totalization data by performing totalization work regarding ‘How many times which group tweeted at which time point? ’ with respect to learning classification information, according to a previously designated unit time point and group information.

In the present second exemplary embodiment, the learning processing unit 52 is adapted to be operated as follows, when the learning data extraction processing unit 42 extracts new additional learning data. Firstly, the learning processing unit 52 calculates influence data indicating an influence of each node. In addition to that, the learning processing unit 52 save-processes the influence data and totalization results Xₛ and yₛ (s=1, 2, . . . , S) of each time point and each group (totalization data processed information) as information resulting from subjecting learning totalization data used for the calculation to process, into the learning processing information saving unit 21B.

Herein, Xₛ represents a matrix obtained by extracting values from a first row of X to a T−s-th row thereof depicted in the form of the Expression 3, and ys=(yₛ₊₁, . . . y_{T})′ represents a sum of the numbers of times of tweets (the number of postings) concerning all nodes at each time point.

In the second exemplary embodiment, it is assumed that influence data indicating the influence of group is given by a matrix shown in an Expression 4 below. In addition, an influence of each node is calculated on the basis of the influence of the group.

$$\begin{matrix}[ Equation 4 ] & \\ β = ( \begin{matrix} {β}_{11} & {β}_{12} & … & {β}_{1 G} \\ {β}_{21} & {β}_{22} & … & {β}_{2 G} \\ ⋮ & ⋮ & ⋮ & ⋮ \\ {β}_{S 1} & {β}_{S 2} & … & {β}_{SG}\end{matrix} ) & ( 4 )\end{matrix}$$

in which s=1, 2, . . . , S, and g=1, 2, . . . , G.

[Equation 5]

ƒ(yₛ,Xₛ,βₛ)+λP(βₛ),(s=1,2, . . . ,S) (5)

In the matrix shown in the above Expression 4, each row represents that it is a future of how many time points ahead under a unit time point (unit totalization time) (time points up to a future of S time points ahead as seen from a certain reference time point), and each column represents each group. In addition, a value of each element β_{sg} in the matrix represents the influence of each group.

Herein, the learning processing unit 52 is adapted to calculate β that minimizes the above Expression 5, as influence data indicating the influence of group. The sign λ is a parameter for adjusting stability of learning results, and referred to as a regularization parameter.

At this time, the influence of node can be defined as a sum of influences of a group to which the node belongs.

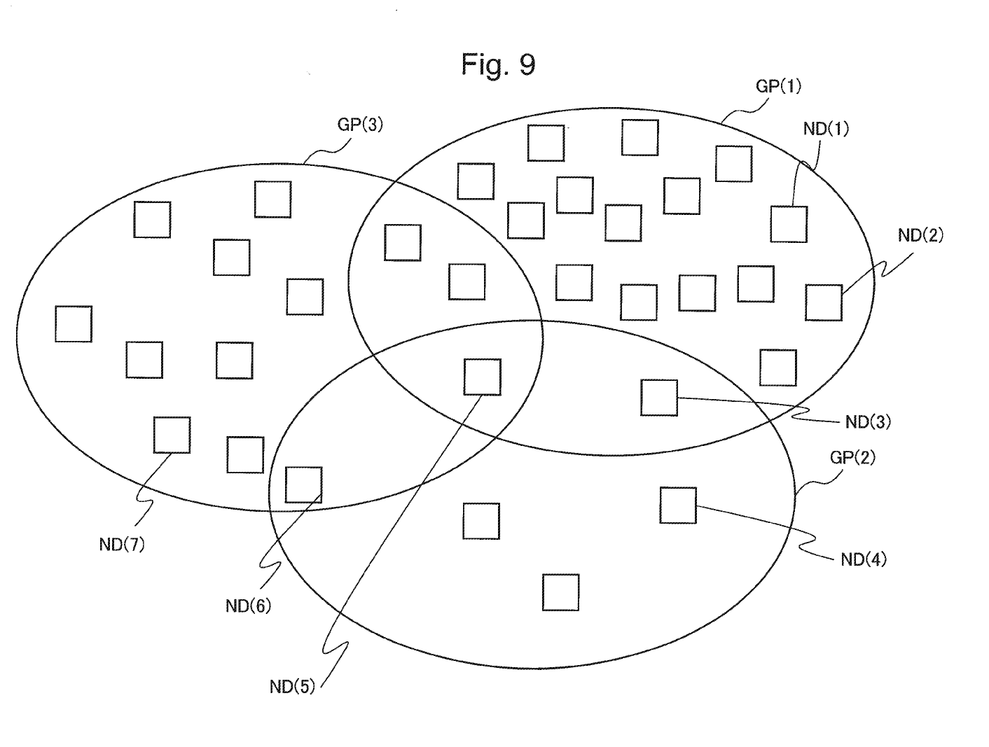

In other words, the learning processing unit 52 is adapted to cause the influence processing function 52B to calculate, as the influence of each node, a sum of the influences of a group to which the each node belongs, on the basis of the calculated influence 13 of the group. Hereinbelow, a description will be given of a method for the influence processing function 52B calculating an influence of each node on the basis of an influence of each group, on the basis of FIG. 9.

FIG. 9 depicts an example of grouping of nodes ND(1) to ND(n) in which the nodes are divided into three groups: groups GP(1) to GP(3). Nodes ND(1) and ND(2) belong only to group GP(1). Nodes ND(4) and ND(7), respectively, belong only to group GP(2) and group GP(3), respectively. In addition, node ND(3) belongs to both of the groups GP(1) and GP(2); node ND(6) belongs to both of the groups GP(2) and GP(3); and node ND(5) belongs to all of the groups GP(1) to GP(3).

In this case, influences of the nodes ND(1) and ND(2) are equal to an influence of the group GP(1), and influences of the respective nodes ND(4) and ND(7) are equal to the influences of the respective groups GP(2) and GP(3).

On the other hand, the influence of the node ND(3) belonging to both of the groups GP(1) and GP(2) is calculated as a total of the respective influences of the groups GP(1) and GP(2). Similarly, an influence of the node ND(6) is calculated as a total of the respective influences of the groups GP(2) and GP(3). Additionally, an influence of the node ND(5) is calculated as a value obtained by adding all influences of the groups GP(1) to GP(3). In other words, it is adapted such that the influences of the nodes belonging to the plurality of groups are larger.

### (Regularization Function)

In addition, the learning processing unit 52 including the calculation function adopting the regularization method for preventing overfitting is adapted to execute processing by employing, as elements of the above Expression 5, Expression 6 below and Expression 7 below representing L1 regularization or Expression 8 below representing L2 regularization. Po(x, α) represents a value of density function at x for a Poisson distribution with a mean α.

$$\begin{matrix}[ Equation 6 ] & \\ f ( {y}_{s} , {X}_{s} , {β}_{s} ) = - {\sum }_{t = s + 1}^{T} log ( Po ( {y}_{t} , exp ( {\sum }_{g = 1}^{G} {β}_{sg} {x}_{( t - s ) g} ) ) ) & ( 6 ) \\ [ Equation 7 ] & \\ P ( {β}_{s} ) = {\sum }_{g = 1}^{G} \vert {β}_{sg} \vert & ( 7 ) \\ [ Equation 8 ] & \\ P ( {β}_{s} ) = {\sum }_{g = 1}^{G} {β}_{sg}^{2} & ( 8 )\end{matrix}$$

### (Combining Processing)

Herein, the learning processing information saving unit 21B after saving processing or update processing performed by the learning processing unit 52 is brought into a state where Xₛ and yₛ (s=1, 2, . . . , S) as past totalization data processed information is saved as pre-processing data, as described above. Accordingly, in this case, the learning processing unit 52 is adapted, after having received learning totalization data in real-time from the learning data totalization function 62A, to cause the relearning processing function 51B to calculate-process influence data using the pre-processing data. Herein, the learning totalization data is information obtained by cross-totalizing in the form of the above Expression 3.

In the second exemplary embodiment, the learning processing unit 52 is adapted as follows. Firstly, when the learning data extraction processing unit 42 extracts a new effective learning period, the learning processing unit 52 calculate-processes:

\tilde{X}ₛ and \tilde{y}ₛ

which are totalization data processed information based on additional learning data within the effective learning period. In addition to that, the learning processing unit 52 acquires Xₛ and yₛ that are past totalization data processed information from the learning processing information saving unit 21B, and combine-processes the processed information:

\tilde{X}ₛ and \tilde{y}ₛ

with the Xₛ and yₛ as the pre-processing data in a form represented by Expression 9 below.

[Equation 9]

(X′ₛ,\tilde{X}′ₛ)′,(y′ₛ,\tilde{y}′ₛ)′ (9)

In addition, the learning processing unit 52 is adapted to calculate influence data in the same manner as above by substituting the content of the combining processing represented by the Expression 9 into the Expression 5, and to store-process the calculated influence data in the learning processing information saving unit 21A. In this way, calculation for totalization concerning existing learning data (calculation of pre-processing for obtaining Xₛ and yₛ) can be omitted, as a result of which new learning of influence of node can be efficiently achieved.

At this time, when addition of new learning data changes the result of grouping for each node, learning totalization data concerning the existing learning data may be recalculated.

### (Prediction of Number of Postings)

Hereinbelow, a description will be given of structures of the totalization information unit 62 and the prediction processing unit 72 concerning prediction of the number of postings.

In the second exemplary embodiment, it is adapted such that the prediction processing unit 72 executes prediction processing based on influence data calculated by the learning processing unit 52 and separately acquired prediction data.

For example, when a result from grouping and totalization processing performed regarding prediction data, similarly to additional learning data, is represented by z=(z1, . . . , zG), the prediction processing unit 72 is adapted to predict the number of postings in a future of s time points ahead by Expression 10 below.

$$\begin{matrix}[ Equation 10 ] & \\ {\sum }_{g = 1}^{G} {β}_{sg} {z}_{g} & ( 10 )\end{matrix}$$

This presupposes that, when predicting the number of postings in a future as seen from a certain time point, only the number of postings at the time point is used.

Next, a description will be given of a case extending such that when predicting the number of postings in a future, the numbers of postings not only at a single time point but also at latest plural time points including the time point are used.

In this case, when predicting the number of postings in a future as seen from a certain time point, there are used the numbers of postings at the latest past plural time points including the number of postings at the certain time point. For example, when using numbers of postings at latest past A time points including a certain time point, prediction totalization data generated by the prediction data totalization function 62B is represented in a form of Expression 11 below.

$$\begin{matrix}[ Equation 11 ] & \\ Z = ( \begin{matrix}{Z}_{11} & {Z}_{12} & … & {Z}_{1 G} \\ {Z}_{21} & {Z}_{22} & … & {Z}_{2 G} \\ ⋮ & ⋮ & ⋱ & ⋮ \\ {Z}_{A 1} & {Z}_{A 2} & … & {Z}_{AG}\end{matrix} ) & ( 11 )\end{matrix}$$

The prediction processing unit 72 is adapted to calculate, using the prediction totalization data, a prediction value of the number of postings in a future by the form of the above Expression 10. When performing prediction at time points in real-time, prediction data acquisition and prediction processing are performed at a previously designated time interval (prediction interval).

Considering the influences of nodes changing from time to time and possibility of appearance of a new node having influence along with the elapse of time, the second exemplary embodiment has employed a structure that periodically performs, together with acquisition of additional learning data and updating of pre-processing data, relearning of the influences of the nodes. In this way, appropriate data updated by pre-processing can be used for relearning, so that appearance prediction concerning the number of postings in the future can be achieved rapidly and accurately.

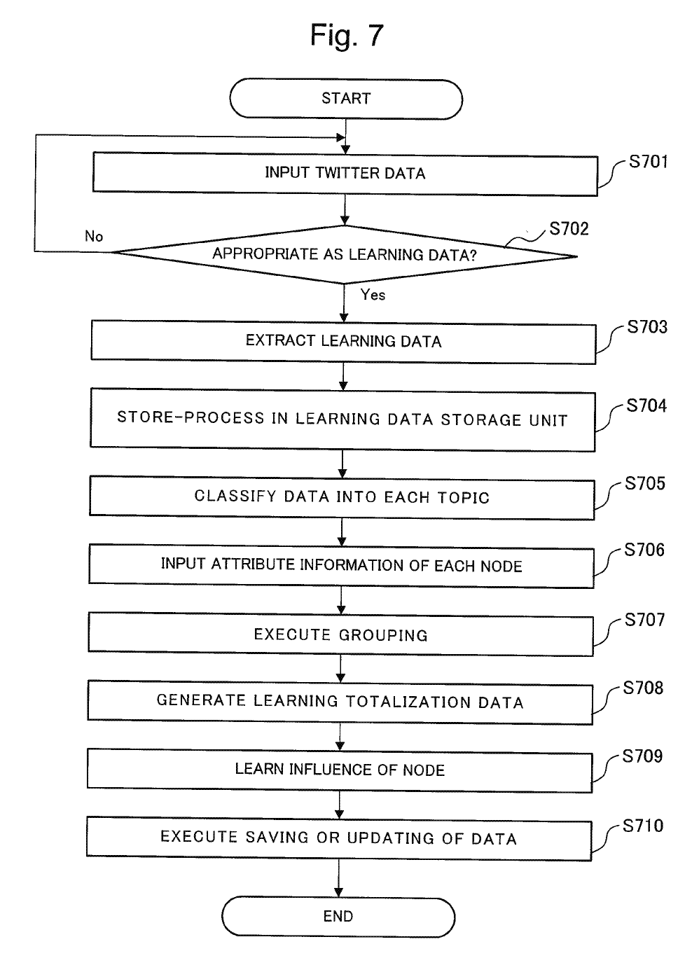

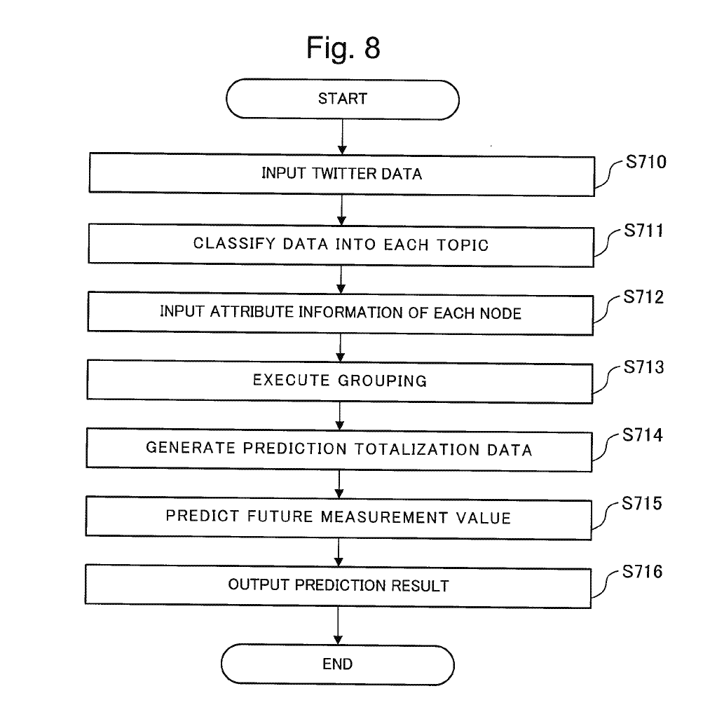

(Description of Operation) Next, a description will be given of a content of operation control by the data concentration prediction device depicted in FIG. 6 on the basis of flowcharts depicted in FIGS. 7 and 8. Hereinbelow, in order to avoid descriptive complications, the description will be presented regarding learning and prediction concerning a single topic. When a plurality of topics is designated, learning and prediction will be performed for each of the topics in the same manner as that described below.

### (Learning Processing)

Firstly, learning processing of time-series data will be described on the basis of FIG. 7.

Text data tweeted on the Twitter by the users (senders) as the plurality of nodes ND (1 to n) is input to the learning data input unit 12A via the network 92. At this time, respective pieces of information concerning ‘a time point at which a tweet was sent’, ‘a node that tweeted’, and ‘a topic to which the text data belongs’ are also simultaneously input. As described above, the learning data input unit 12A transmits Twitter data configured by these pieces of information to the learning data extraction processing unit 42 (FIG. 7: S701).

Next, the learning data extraction processing unit 42, after having received the Twitter data from the learning data input unit 12A, will continuously determine whether or not the Twitter data at each unit time point (each unit totalization time) is appropriate as additional learning data on the basis of the expressions 1 and 2 (FIG. 7: S702).

Specifically, on the basis of the number of postings (prediction attribute information) of the Twitter data received at each time point in real-time from the learning data input unit 12A, the learning data extraction processing unit 42 executes a determination based on the above Expressions 1 and 2 (FIG. 7: S702). Next, the learning data extraction processing unit 42 continuously extracts Twitter data concerning a determination that it is appropriate as additional learning data, together with Twitter data at latest past S time points (FIG. 7: S703).

Specifically, when provided with the Expression 1, the learning data extraction processing unit 42 determines that Twitter data concerning a time point in real-time is appropriate as additional learning data (FIG. 7: YES in S702). In addition to that, the learning data extraction processing unit 42 extracts the Twitter data concerning the determination (including the Twitter data concerning the latest past S time points) and moves to extraction processing of subsequent Twitter data (FIG. 7: S703).

On the other hand, when not provided with the Expression 1, the learning data extraction processing unit 42 determines that the Twitter data is inappropriate as additional learning data and, does not extract the Twitter data concerning the determination and moves to processing of subsequent Twitter data (FIG. 7: NO in S702)

Next, the learning data extraction processing unit 42, after having continuously determined that Twitter data is appropriate as additional learning data by the above, will store-process Twitter data (including the data concerning the latest past S time points) within an effective learning period concerning the continuous determination in the learning data storage unit 21A collectively at one time. When past learning data is present in the learning data storage unit 21A, it will be additionally stored (FIG. 7: S704).

When the learning data extraction processing unit 42 collectively store-processes new Twitter data within the effective learning period in the data storage unit 21A (FIG. 7: S704), the learning processing unit 52 acquires the new Twitter data as additional learning data from the data storage unit 21A (FIG. 7: S705).

Next, the learning processing unit 52 classifies the new Twitter data into each topic on the basis of three pieces of information: node information, time point information, and text data. The learning processing unit 52 transmits learning classification information of each topic obtained by the classification (information of Twitter data belonging to a single topic) to the information totalization unit 62 (FIG. 7: S705).

Next, the attribute information input unit 12B, after having received attribute information of each node linked with each text data input to the learning data input unit 12A, will transmit the attribute information to the grouping function 62C (FIG. 7: S706).

The grouping function 62C executes creation of groups (grouping) of all nodes concerning the Twitter data received within the effective learning period on the basis of the attribute information of each node acquired from the attribute information input unit 12B. Then, the grouping function 62C transmits group information generated by the grouping to the learning data totalization function 62A (FIG. 7: S707).

Next, the information totalization function 62A generates learning totalization data (cross-totalization data) in the form of the above Expression 3 on the basis of the learning classification information acquired from the learning processing unit 52 and the group information received from the grouping function 62C, and transmits the generated learning totalization data to the learning processing unit 52 (FIG. 7: S708).

Next, the learning processing unit 52, after having received the learning totalization data from the learning data totalization function 62A, will acquire previously generated and pre-saved past totalization data processed information from the learning processing information saving unit 21B and cause the relearning processing function 51B to organize these pieces of information in the form of the above Expression 9. Then, the learning processing unit 52 calculates the influence of each group in the form of the above Expression 4 and, based on a value of the influence thereof, causes the influence processing function 52B to calculate influence data by using a sum of influences of a group to which the each node belongs as the influence of the node (FIG. 7: S709).

On the other hand, when, at the time of calculation of influence data, any saved past totalization data processed information is not present in the learning processing information saving unit 21B, the leaning processing unit 52 calculates the influence of the group in the form of the above Expression 4 on the basis of the learning totalization data received from the learning data totalization function 62A in real-time. Then, based on the value of the influence, the learning processing unit 52 causes the influence processing function 52B to calculate influence data indicating the influence of the each node (FIG. 7: S709).

At the time of calculation of the influence of the group, the learning processing unit 52 calculates, in the form represented by the above Expression 4, an influence 13 of the group that minimizes the value of the above Expression 5 using the above Expression 6 and the above Expression 7 representing L1 regularization or the above Expression 8 representing L2 regularization. The calculation function adopting the regularization method in the learning processing unit 52 can prevent overfitting. This allows improvement in stability of learning results (FIG. 7 S709).

Next, the learning processing unit 52 causes the data update processing function 51A to update information in the learning processing information saving unit 21B by influence data calculated in real-time and totalization data processed information concerning the calculation. In addition, when there is no saved information in the learning processing information saving unit 21B, the learning processing unit 52 store-processes the influence data calculated in real-time and the totalization data processed information concerning the calculation in the learning processing information saving unit 21B (FIG. 7: S710).

### (Prediction of Number of Postings)

Next, on the basis of FIG. 8, a description will be given of a series of operation contents for predicting the number of postings in a future as seen from a time point where prediction data is observed (processing for predicting data concentration concerning the number of future postings).

The prediction data input unit 12C is input Twitter data for predicting data concentration in response to a prediction request issued at a preset time interval (prediction interval). At this time, the respective pieces of information concerning ‘a time point at which a tweet was sent’, ‘a node that tweeted’, and ‘a topic to which the text data belongs’ are also input together therewith. The prediction data input unit 12C transmits Twitter data as prediction data configured by these pieces of information to the prediction processing unit 72 (FIG. 8: S711).

Next, the prediction processing unit 72 classifies the acquired each Twitter data into each topic on the basis of the three pieces of information: node information, time point information, and text data. The prediction processing unit 72 transmits prediction classification information of each topic obtained by the classification (information of Twitter data belonging to a single topic) to the information totalization unit 62 (FIG. 8: S712).

Next, the attribute information input unit 12B inputs, from the outside of the device, attribute information of each node linked with each text data received by the prediction data input unit 12C, and also transmits the attribute information to the information totalization unit 62 (FIG. 8: S713).

The information totalization unit 62 causes to the grouping function 62C to execute grouping of nodes on the basis of the attribute information of the nodes acquired from the attribute information input unit 12B, and transmits the generated group information to the information totalization unit 62 (FIG. 8: S714).

Next, the information totalization unit 62 generates prediction totalization data (cross-totalization data) of each topic in the form of the above Expression 11 on the basis of the prediction classification information acquired from the prediction processing unit 72 and the group information received from the group creating unit 62C, and also transmits the generated prediction totalization data to the prediction processing unit 72 (FIG. 8: S715).

Next, the learning processing unit 52 acquires the influence data formed in the form of the Expression 4 previously saved in the learning processing information saving unit 21B and also transmits the influence data to the prediction processing unit 72. Then, the prediction processing unit 72 predicts the number of future postings. Specifically, the prediction processing unit 72 predicts the number of future postings as seen from a time point at which prediction data is observed, using the influence data (in the form of the Expression 4) and the prediction totalization data (in the form of the Expression 11) received from the information totalization unit 62. In other words, the prediction processing unit 72 calculates a prediction value of the number of future postings in the form of the above Expression 10. At that time, when needed, the prediction processing unit 72 store-processes the prediction value concerning the calculation in the data storage means 21 (FIG. 8: S716).

Next, the prediction processing unit 72 causes the prediction result output function 71A to output the calculated prediction value of the number of future postings to the outside of the device (FIG. 8: S717). In this way, a Twitter client, a node, or the like that has acquired the prediction value can grasp the prediction value concerning future data fluctuation and also can take some measures thereagainst as needed, so that problems such as flaming on the Twitter can be prevented in advance.

In addition, it may be adapted such that the content executed at each step in the above respective steps S701 to S717 (FIGS. 7 and 8) is programmed and the series of respective control programs are realized by a computer.

### Results of Second Exemplary Embodiment

Even in the second exemplary embodiment, the learning data extraction processing unit 42 can extract an effective learning period adapted to tendencies of fluctuation of various kinds of data and Twitter data within the period by the methods based on the above Expressions 1 and 2. Accordingly, in this way, problems such as excessive collection of data and shortage of data can be automatically prevented.

In addition, in the data concentration prediction device 82, the learning data extraction processing unit 42 performs totalization processing or the like on additional learning data significant for predicting data concentration extracted thereby, and, based on the data after the processing, the prediction processing unit 72 predicts the number of future postings. In other words, a highly reliable prediction value can be obtained by using, as original data, accurately extracted additional learning data for predicting data concentration. Accordingly, in this way, the influences of nodes and the like causing a flaming on the Twitter can be accurately grasped, as well as damage caused by harmful rumors and the like can be prevented in advance.

Furthermore, grouping of nodes (senders) by the grouping function 62C can limit the number of unstable nodes (senders) to a preset number of groups (a fixed number). Accordingly, calculation of cross-totalization data, influence data, and the like can be smoothly performed, and also results of the calculation can be stabilized. In addition, the calculation function adopting the regularization method employed in the learning processing unit 52 can prevent overfitting, so that precise and stable influences of nodes can be repeatedly obtained.

Furthermore, the data concentration prediction device 82 according to the present second exemplary embodiment can automatically and efficiently perform extraction of an effective learning period, relearning, and the like, whereby acceleration of prediction processing and improvement in prediction accuracy can be achieved. Thus, the automated series of processes allow reduction in human cost and human error, particularly, in scenes of practical applications.

### Examples of Applications Concerning Structures and the Like

The second exemplary embodiment has described the case of introducing both of the grouping function 62C included in the data concentration prediction device 82 and the calculation function adopting the regularization method included in the learning processing unit 52, from the viewpoints of accelerated calculation processes, stabilized data, and the like. However, the device of the second exemplary embodiment may be adapted such that only any one of them is introduced therein.

In addition, the data concentration prediction device 82 according to the second exemplary embodiment has employed the structure in which the learning processing unit 52 acquires influence data from the learning processing information saving unit 21B and also transmits the influence data to the prediction processing unit 72 (FIG. 8: S716). However, the prediction processing unit 72 may be adapted to directly acquire the influence data from the learning processing information saving unit 21B.

Furthermore, information concerning a prediction interval preset by an external input may be adapted to be stored in a memory juxtaposed with the data storage means 21. In other words, the data input means 12 may acquire information concerning a prediction interval to input prediction data in accordance with the information.

Additionally, the main point of the second exemplary embodiment is to grasp distinctive data fluctuation, such as flaming on the Twitter. For this reason, the above Expression 1 has been employed to effectively grasp an increasing tendency of the number of postings, and based on the Expression 1, a fluctuation permission range has been calculated and additional learning data has been extracted (FIG. 7: S702; S703). However, when not only the increasing tendency of data but also reducing tendency thereof is desired to be accurately grasped, the following Expression 12 may be employed together with the above Expression 1.

[Equation 12]

\hat{μ}_{T′+1}−α\hat{σ}_{T′+1}>y_{T′+1} (12)

However, when only a reducing tendency of data is desired to be effectively grasped, the Expression 12 may be employed instead of the above Expression 1. This allows flexible data extraction to be performed according to characteristics of various kinds of time-series data or a situation to be desired to grasp, so that data prediction in diverse scenes can be achieved.

In addition, the present second exemplary embodiment has described the structure and operation employing Twitter data as time-series data and attribute information linked therewith. However, the data concentration prediction device 82 according to the present invention can achieve operation control of various kinds of time-series data appearing under a variety of environments in the same manner as the above-described respective step contents (FIGS. 7 and 8: S701 to S717). In other words, the data concentration prediction device 82 can accurately predict future appearance of data concerning natural phenomena such as earthquake waveforms and sea-level fluctuation in tsunami, in addition to the number of articles posted on social media on the Web, such as the Twitter and blogs. Furthermore, the data concentration prediction device 82 can accurately predict future appearance of data concerning states of individual components obtained from sensors installed in automobiles and factory lines. Moreover, the data concentration prediction device 82 can accurately predict future appearance of data concerning human activities such as power consumption in daily life, and the like.

The exemplary embodiments described above are preferable specific examples in the data concentration prediction device, the data concentration prediction method, and the program therefor, and various technically preferable limitations may be added. However, the technical scope of the present invention is not limited to these exemplary embodiments, unless otherwise specified as limiting the invention.

The following is a summary of main points of the novel technical contents regarding the exemplary embodiments described above. However, the present invention is not necessarily limited thereto.

### (Supplementary Note 1)

A data concentration prediction device including: a data input means for receiving data transmitted from a plurality of nodes together with corresponding attribute data to receive as time-series data; a data storage means for storing the received time-series data as learning data; and a data concentration prediction means for analyzing a data structure of the stored time-series data to predict subsequent data concentration,

the data concentration prediction means including a learning data extraction processing unit that temporarily store-processes the time-series data received by the data input means, over time at each preset unit time point, and continuously extract-processes, as additional learning data necessary for predicting the subsequent data concentration, the time-series data deviating from a fluctuation permission range preset on the basis of time-series data within a past fixed period based on a time point immediately preceding an input time point of each time-series data using the temporarily store-processed data, and

the learning data extraction processing unit including a learning data storage processing function that collectively store-processes the continuously extracted additional learning data in the data storage means.

### (Supplementary Note 2)

The data concentration prediction device according to the supplementary note 1, in which the learning data extraction processing unit calculates and sets the fluctuation permission range to be set when extracting the additional learning data, on the basis of a mean value and variance of attribute data concerning the prediction of the data concentration included in the time-series data within the past fixed period.

### (Supplementary Note 3)

The data concentration prediction device according to the supplementary note 1 or 2, in which the data concentration prediction means includes:

an information totalization unit that includes a learning data totalization function that correlates the attribute data concerning the prediction of the data concentration included in the additional learning data collectively stored in the data storage means with the unit time point to totalize as learning totalization data; and

a learning processing unit that calculates influence data indicating an influence of each node on a prediction value concerning the data concentration in a relationship with the learning totalization data, and save-processes the influence data and the learning totalization data used for the calculation in the data storage means.

### (Supplementary Note 4)

The data concentration prediction device according to the supplementary note 3,

in which the information totalization unit further includes a prediction data totalization function that, in response to a prediction request issued at a preset time interval, correlates the attribute data concerning the prediction included in the time-series data received by the data input means with the unit time point to totalize as prediction totalization data; and

in which the data concentration prediction means further includes a prediction processing unit that calculate-processes the prediction value on the basis of the prediction totalization data and the influence data.

### (Supplementary Note 5)

The data concentration prediction device according to the supplementary note 3 or 4,

in which the learning processing unit further includes a data update processing function that, when, at a time of calculation of the influence data in real-time, previously saved influence data and learning totalization data are in the data storage means, updates the saved information in the data storage means by influence data calculated in real-time and learning totalization data used for the calculation.

### (Supplementary Note 6)

The data concentration prediction device according to the supplementary note 3 or 4,

in which the learning processing unit further includes a relearning processing function that, when, at a time of calculation of the influence data in real-time, previously saved learning totalization data is in the data storage means, combine-processes the saved learning totalization data and learning totalization data acquired from the information totalization unit in real-time, and calculates the influence data using the combine-processed learning totalization data.

### (Supplementary Note 7)

The data concentration prediction device according to the supplementary note 5,

in which the learning processing unit further includes a relearning processing function that, when, at the time of calculation of the influence data in real-time, previously saved learning totalization data is in the data storage means, combine-processes the saved learning totalization data and learning totalization data acquired from the information totalization unit in real-time, and calculates the influence data using the combine-processed learning totalization data.

### (Supplementary Note 8)

The data concentration prediction device according to the supplementary note 7,

in which, when save-processing the learning totalization data used for calculation of the influence data or updating the saved information in the data storage means by the data update processing function, the learning processing unit executes the saving processing and the updating using totalization data processed information resulting from subjecting the learning totalization data to a predetermined process, and

the relearning processing function performs combining processing of the totalization data processed information and totalization data processed information resulting from subjecting learning totalization data acquired in real-time to the predetermined process.

### (Supplementary Note 9)

The data concentration prediction device according to any one of the supplementary notes 4 to 8,

in which the information totalization unit includes:
a grouping function that determines a group on the basis of a commonality of the attribute data of the each node and causes the each node to belong to one or more groups to generate group information; and
a group totalization function that correlates the group information with the time point instead of the attribute data concerning the prediction to generate the learning totalization data or the prediction totalization data.

### (Supplementary Note 10)

The data concentration prediction device according to the supplementary note 9,

in which the learning processing unit includes an influence processing function that, at a time of calculation of the influence data concerning the each node, calculates an influence of each group on the data concentration in a relationship with the learning totalization data and obtains, for the each node, an addition value of influences of the one or more groups to which the each node belongs, as the influence of the each node.

### (Supplementary Note 11)

The data concentration prediction device according to any one of the supplementary notes 3 to 10,

in which the learning processing unit further includes a learning classification function that classifies the additional learning data collectively stored in the data storage means into each data content and transmits learning classification information generated thereby to the information totalization unit; and

in which the information totalization unit generates the learning totalization data using the learning classification information.

### (Supplementary Note 12)

The data concentration prediction device according to any one of the supplementary notes 4 to 11,

in which the prediction processing unit further includes a prediction classification function that classifies the time-series data received by the data input means in response to the prediction request into each data content and transmits prediction classification information generated thereby to the information totalization unit; and

in which the information totalization unit generates the prediction totalization data using the prediction classification information.

### (Supplementary Note 13)

The data concentration prediction device according to any one of the supplementary notes 4 to 12, in which the prediction processing unit further includes a prediction result output function that outputs the calculated prediction value as a future data fluctuation tendency to an outside of the device.

### (Supplementary Note 14)

The data concentration prediction device according to any one of the supplementary notes 3 to 13, in which the learning processing unit calculates the influence data by a calculation function adopting a regularization method that prevents overfitting.

### (Supplementary Note 15)

The data concentration prediction device according to the supplementary note 14, in which the learning processing unit incorporates L1 regularization as the regularization method.

### (Supplementary Note 16)

The data concentration prediction device according to the supplementary note 14, in which the learning processing unit incorporates L2 regularization as the regularization method.

### (Supplementary Note 17)

A data concentration prediction method, performed with a data concentration prediction device including a data input means for receiving data transmitted from a plurality of nodes together with corresponding attribute information to receive as time-series data, a data storage means for storing the received time-series data as learning data, and a data concentration prediction means for analyzing a data structure of the stored time-series data to predict subsequent data concentration,

the data concentration prediction means including a learning data extraction processing unit that extracts and processes time-series data for predicting the data concentration, in which the method includes:

temporarily store-processing the time-series data received by the data input means, over time at each preset unit time point;

determining whether or not each time-series data deviates from a fluctuation permission range set on the basis of time-series data within a past fixed period based on a time point immediately preceding an input time point of each time-series data using the temporarily store-processed data;

when deviation from the fluctuation permission range is determined, continuously extracting time-series data concerning the determination as additional learning data necessary for predicting the subsequent data concentration;
collectively store-processing the continuously extracted additional learning data in the data storage means, the series of respective step contents being executed in order by the learning data extraction processing unit; and,

causing a prediction processing unit of the data concentration prediction means to predict the data concentration on the basis of a data structure of the time-series data specified by the additional learning data collectively stored in the data storage means and existing learning data.

### (Supplementary Note 18)

The data concentration prediction method according to the supplementary note 17, in which, before prediction by the prediction processing unit after the learning data extraction processing unit collectively store-processes the continuously extracted additional learning data,

the method correlates attribute data concerning the prediction of the data concentration included in the collectively stored additional learning data with the unit time point to totalize as learning totalization data;

calculates influence data indicating an influence of each node on a prediction value concerning the data concentration in a relationship with the learning totalization data; and

updates the saved information in the data storage means by the influence data and learning totalization data used for the calculation;

these series of respective step contents being executed in order by the data concentration prediction means.

### (Supplementary Note 19)

A data concentration prediction program executed with a data concentration prediction device including a data input means for receiving data transmitted from a plurality of nodes together with corresponding attribute information to receive as time-series data, a data storage means for storing the received time-series data as learning data, and a data concentration prediction means for analyzing a data structure of the stored time-series data to predict subsequent data concentration, in which the program includes:

a data temporary storage processing function that temporarily store-processes the time-series data received by the data input means, over time at each preset unit time point;

a fluctuation permission determination function that determines whether or not each time-series data deviates from a fluctuation permission range set on the basis of time-series data within a past fixed period based on a time point immediately preceding an input time point of each time-series data using the temporarily store-processed data;

a learning data extraction function that, when deviation from the fluctuation permission range is determined, continuously extracts time-series data concerning the determination as additional learning data necessary for predicting the subsequent data concentration;

a learning data storage processing function that collectively store-processes the continuously extracted additional learning data in the data storage means; and

a prediction processing function that predicts data concentration on the basis of a data structure of the time-series data specified by the collectively stored additional learning data and existing learning data,

these respective information processing functions being implemented by a computer provided in the data concentration prediction means.

### (Supplementary Note 20)

The data concentration prediction program according to the supplementary note 19, in which the program includes:

a learning data totalization function that correlates attribute data concerning the prediction of the data concentration included in the additional learning data collectively stored in the data storage means with the unit time point to totalize as learning totalization data;

an influence data calculation function that calculates influence data indicating an influence of each node on a prediction value concerning the data concentration in a relationship with the learning totalization data;

a data update processing function that updates the saved information in the data storage means by the influence data and learning totalization data used for the calculation; and

a prediction value calculation and storage function that, using the updated saved information as the existing learning data, calculates the prediction value based on time-series data received in real-time, and stores the calculated prediction value in the data storage means,

these information processing functions being realized by the computer.

This application is based upon and claims the benefit of priority from Japanese Patent Application No. 2012-200440, filed on Sep. 12, 2012, the disclosure of which is incorporated herein in its entirety.

### INDUSTRIAL APPLICABILITY

The present invention is usable, for example, for a system or the like by which a company monitors whether harmful rumors on the company's own products occur on the Web in the future.

### REFERENCE SIGNS LIST

11, 12 Data input means
12A Learning data input unit
12B Attribute information input unit
12C Prediction data input unit
21 Data storage means
21A Learning data storage unit
21B Learning processing information saving unit
31, 32 Data concentration prediction means
41, 42 Learning data extraction processing unit
41A, 42A Learning data storage processing function
51, 52 Learning processing unit
51A Data update processing function
51B Relearning processing function
52A Learning classification function
52B Influence processing function
61, 62 Information totalization unit
61A, 62A Learning data totalization function
61B, 62B Prediction data totalization function
62C Grouping function
63 Group totalization function
71, 72 Prediction processing unit
71A Prediction result output function
72A Prediction classification function
81, 82 Data concentration prediction device

What is claimed is:

1. A data concentration prediction device comprising: a data input unit which receives data transmitted from a plurality of nodes together with corresponding attribute data to receive as time-series data; a data storage unit which stores the received time-series data as learning data; and a data concentration prediction unit which analyzes a data structure of said stored time-series data to predict subsequent data concentration,
said data concentration prediction unit including a learning data extraction processing unit that temporarily store-processes the time-series data received by said data input unit, over time at each preset unit time point, and continuously extract-processes, as additional learning data necessary for predicting said subsequent data concentration, said time-series data deviating from a fluctuation permission range preset on the basis of time-series data within a past fixed period based on a time point immediately preceding an input time point of each time-series data using the temporarily store-processed data, and
the learning data extraction processing unit including a learning data storage processing function that collectively store-processes said continuously extracted additional learning data in said data storage unit.

2. The data concentration prediction device according to said claim 1,
wherein said learning data extraction processing unit calculates and sets the fluctuation permission range to be set when extracting said additional learning data, on the basis of a mean value and variance of attribute data concerning the prediction of said data concentration included in the time-series data within said past fixed period.

3. The data concentration prediction device according to said claim 2,
wherein said data concentration prediction unit includes:
an information totalization unit that includes a learning data totalization function that correlates the attribute data concerning the prediction of said data concentration included in the additional learning data collectively stored in said data storage unit with said unit time point to totalize as learning totalization data; and
a learning processing unit that calculates influence data indicating an influence of each node on a prediction value concerning said data concentration in a relationship with said learning totalization data, and save-processes the influence data and learning totalization data used for said calculation in said data storage unit.

4. The data concentration prediction device according to said claim 3,
wherein said information totalization unit further includes a prediction data totalization function that, in response to a prediction request issued at a preset time interval, correlates the attribute data concerning said prediction included in the time-series data received by said data input unit with said unit time point to totalize as prediction totalization data; and
wherein said data concentration prediction unit further includes a prediction processing unit that calculate-processes said prediction value on the basis of said prediction totalization data and said influence data.

5. The data concentration prediction device according to said claim 4,
wherein said learning processing unit further includes a data update processing function that, when, at a time of calculation of said influence data in real-time, previously saved influence data and learning totalization data are in said data storage unit, updates the saved information in said data storage unit by influence data calculated in real-time and learning totalization data used for said calculation.

6. The data concentration prediction device according to said claim 5,
wherein said learning processing unit further includes a relearning processing function that, when, at the time of calculation of said influence data in real-time, previously saved learning totalization data is in said data storage unit, combine-processes the saved learning totalization data and learning totalization data acquired from said information totalization unit in real-time, and calculates said influence data using the combine-processed learning totalization data.

7. The data concentration prediction device according to said claim 4,
wherein said information totalization unit includes:
a grouping function that determines a group on the basis of a commonality of the attribute data of said each node and causes the each node to belong to one or more groups to generate group information; and
a group totalization function that correlates the group information with said time point instead of the attribute data concerning said prediction to generate said learning totalization data or said prediction totalization data.

8. The data concentration prediction device according to said claim 7,
wherein said learning processing unit includes an influence processing function that, at a time of calculation of the influence data concerning said each node, calculates an influence of each group on said data concentration in a relationship with said learning totalization data and obtains, for said each node, an addition value of influences of the one or more groups to which said each node belongs, as the influence of said each node.

9. A data concentration prediction method, performed with a data concentration prediction device including a data input means for receiving data transmitted from a plurality of nodes together with corresponding attribute information to receive as time-series data, a data storage means for storing the received time-series data as learning data, and a data concentration prediction means for analyzing a data structure of said stored time-series data to predict subsequent data concentration,
said data concentration prediction means including a learning data extraction processing unit that extracts and processes time-series data for predicting said data concentration,
the method comprising:
temporarily store-processing the time-series data received by said data input means, over time at each preset unit time point;
determining whether or not each time-series data deviates from a fluctuation permission range set on the basis of time-series data within a past fixed period based on a time point immediately preceding an input time point of each time-series data using the temporarily store-processed data;
when deviation from said fluctuation permission range is determined, continuously extracting time-series data concerning said determination as additional learning data necessary for predicting said subsequent data concentration;
collectively store-processing the continuously extracted additional learning data in said data storage means, the series of respective step contents being executed in order by said learning data extraction processing unit; and
causing a prediction processing unit of said data concentration prediction means to predict said data concentration on the basis of a data structure of said time-series data specified by the additional learning data collectively stored in said data storage means and existing learning data.

10. A non-transitory computer-readable recording medium recording a data concentration prediction program executed with a data concentration prediction device including a data input means for receiving data transmitted from a plurality of nodes together with corresponding attribute information to receive as time-series data, a data storage means for storing the received time-series data as learning data, and a data concentration prediction means for analyzing a data structure of said stored time-series data to predict subsequent data concentration,
wherein the program comprises:
a data temporary storage processing function that temporarily store-processes the time-series data received by said data input means, over time at each preset unit time point;
a fluctuation permission determination function that determines whether or not each time-series data deviates from a fluctuation permission range set on the basis of time-series data within a past fixed period based on a time point immediately preceding an input time point of each time-series data using the temporarily store-processed data;
a learning data extraction function that, when deviation from said fluctuation permission range is determined, continuously extracts time-series data concerning said determination as additional learning data necessary for predicting said subsequent data concentration;
a learning data storage processing function that collectively store-processes the continuously extracted additional learning data in said data storage means; and
a prediction processing function that predicts said data concentration on the basis of a data structure of said time-series data specified by the collectively stored additional learning data and existing learning data,
these respective information processing functions being implemented by a computer provided in said data concentration prediction means.
